(19) United States
(12) Patent Application Publication
(10) Pub. No.: US 2010/0123973 A1
(43) Pub. Date: May 20, 2010

(54) INFORMATION STORAGE MEDIUM AND INFORMATION STORAGE APPARATUS

(75) Inventors: Yasuyuki Ozawa, Kawasaki (JP); Haruhiko Izumi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/569,717

(22) Filed: Sep. 29, 2009

(30) Foreign Application Priority Data
Nov. 14, 2008 (JP) 2008-292534

(51) Int. Cl. G11B 5/596

(52) U.S. Cl. 360/77.08; G9B/5.216

(57) ABSTRACT

According to one embodiment, an information storage medium includes a plurality of sectors arranged in a circumferential direction of a disk-shaped substrate, each sector having a servo pattern that is formed on the substrate and in which information indicating a position in a radial direction of the substrate is magnetically recorded, and a plurality of recording dots that is arranged with a predetermined pitch in the circumferential direction of the substrate and in which information is to be magnetically recorded. The servo pattern has a magnetic pattern arranged in the circumferential direction with a pitch having a predetermined integral ratio to the pitch of the recording dots. A recording dot arranged nearest to the servo pattern among the recording dots in each sector is arranged at a position having a constant phase relationship to the pitch of the servo pattern of the sector comprising the recording dots in any of the sectors.

### CROSS-REFERENCE TO RELATED APPLICATIONS

This application is based upon and claims the benefit of priority from Japanese Patent Application No. 2008-292534, filed on Nov. 14, 2008, the entire contents of which are incorporated herein by reference.

### BACKGROUND

1. Field

One embodiment of the invention relates to an information storage medium and an information storage apparatus comprising the information storage medium.

2. Description of the Related Art

As a technique for improving the recording density of an information storage medium mounted on an information storage apparatus, a magnetic disk of a patterned media system has been recently focused. The magnetic disk of the patterned media system has a structure in which dots that are made of a magnetic body and store therein a minimum unit of information are regularly arranged on the magnetic disk.

FIG. 1 is an exemplary schematic perspective diagram of the structure of the magnetic disk of the patterned media system. A portion cut from the magnetic disk is illustrated in FIG. 1.

A magnetic disk D illustrated in FIG. 1 has a structure in which a plurality of recording dots Q is regularly arranged on a substrate S and information of one bit is magnetically recorded in each recording dot Q. The recording dots are arranged in a circumference shape surrounding the center of the disk and the column of the recording dots forms a track T. Such a magnetic disk of the patterned media system is manufactured by a known manufacturing process that is generally called nanoimprint lithography. Because the invention does not directly relate to the manufacturing process, the explanation of the manufacturing process is omitted herein.

The magnetic disk apparatus mounted with a common magnetic disk, not limited to the patterned media system, records and reproduces target information by positioning a magnetic head by using a servo pattern on the magnetic disk. In a track on the magnetic disk, a servo region in which servo patterns are arranged and a data region in which data is recorded are alternately arranged along the track. A servo pattern is read with a servo sampling frequency, which is indicated by multiplying the number of the servo regions per rotation by the rotation number of the magnetic disk, from the magnetic head that relatively moves along the track of the rotating magnetic disk to obtain the position information of the magnetic head. Based on the position information, servo control in a discrete time region is performed and the magnetic head follows a target track.

FIGS. 2A and 2B are exemplary diagrams of general arrangement of each region in a magnetic disk. Each region of a magnetic disk 90 is illustrated with a magnetic head 91 in FIG. 2A. A partial region R of the magnetic disk 90 is linearly expanded and illustrated in FIG. 2B.

The regions on the magnetic disk 90 are divided into a plurality of zones from zone 0 to zone i in the radial direction and used. In one zone, because the recording frequency is constant, the length of a recording region per bit gradually increases from the inner periphery toward the outer periphery. However, the magnetic disk 90 has a structure in which the recording frequency becomes higher toward an outer zone in a manner that the length of the recording region per bit falls within a constant range over all the zones (a zone constant angular velocity (ZCAV) system). A sector comprises a servo region and a data region following the servo region. As illustrated in FIG. 2A, the magnetic head 91 is mounted on the tip of an arm 92, and specifically, the servo region is arranged in an arcuate shape along a locus 93 to which the magnetic head moves along with rotation of the arm.

Unlike the patterned media system, in a magnetic disk of a continuous medium system, which is conventionally widely used, the servo region and the data region are provided on a uniformly and continuously extending magnetic film. On the other hand, in the magnetic disk of the patterned media system, patterns of a magnetic region/non-magnetic region corresponding to servo information are formed in the servo region by performing a manufacturing process. If the entire servo region is uniformly magnetized, the absence or presence of magnetism is a magnetic pattern indicating servo information. The minute recording dots are discretely arranged in the data region. One recording dot corresponds to one bit of information, and the value of bits is indicated by the magnetic direction. It is necessary to record information after the magnetic head is accurately positioned on recording dots, because the information cannot be recorded between the recording dots in the magnetic disk of the patterned media system. This positioning comprises the positioning of the magnetic head in the radial direction of the magnetic disk and the synchronization of the read/write timing of a signal to the recording head with the passage timing of the recording dots.

FIG. 3 is an exemplary diagram of a relationship between the recording dots and a write clock of the magnetic disk of the patterned media system.

As illustrated in FIG. 3, to record information in the magnetic disk of the patterned media system, it is necessary to generate a write clock that is synchronized with a timing at which the magnetic head 95 passes over the recording dots Q. In addition, to record information in the magnetic disk of the patterned media system, it is necessary to supply write data to the magnetic head 95 in synchronization with the write clock. This synchronization comprises cycle synchronization and phase synchronization. For example, the cycles of a write clock C1 and a write clock C2 illustrated in FIG. 3 are matched with the cycle in which the magnetic head 95 passes the recording dots Q, but the phases are shifted. As a result, if a signal is supplied to the magnetic head 95 based on an appropriate timing of the write clock C1, information is recorded in the recording dots Q. However, if a signal is supplied based on an inappropriate timing of the write clock C2, information is not correctly recorded.

To generate a write clock synchronized with the passage timing of the recording dots, a magnetic disk provided with a write preamble that is a magnetic pattern having the arrangement cycle and the phase of recording dots has been developed (for example, see Japanese Patent Application Publication (KOKAI) No. 2003-157507). Moreover, to adjust the phase of a write clock with the timing at which the magnetic head passes the recording dots, a method for recording information while changing phases to find an optimal phase is disclosed (for example, see Japanese Patent Application Publication (KOKAI) No. 2006-164349).

If the write preamble is provided in each sector of the magnetic disk, information can be written at the timing of the write clock that is generated based on the signal read from a write preamble when the information is written. However, if the write preamble is provided in each sector, the recording dots cannot be arranged in the region, whereby the recording capacity is decreased.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic perspective diagram of the structure of a magnetic disk of a patterned media system;

FIGS. 2A and 2B are exemplary diagrams of general arrangement of each region in the magnetic disk;

FIG. 3 is an exemplary diagram of a relationship between recording dots and a write clock of the magnetic disk of the patterned media system;

FIG. 4 is an exemplary diagram of a hard disk drive as a specific first embodiment of an information storage apparatus;

FIGS. 5A and 5B are exemplary detailed diagrams of the magnetic disk illustrated in FIG. 4;

FIG. 6 is an exemplary block diagram of a configuration of a clock generating module illustrated in FIG. 4;

FIG. 7 is an exemplary diagram of a relationship between a clock generated by the clock generating module illustrated in FIG. 6 and patterns and bits on the magnetic disk;

FIG. 8 is an exemplary diagram of a phase relationship between recording dots and a write clock WCLK;

FIG. 9 is an exemplary schematic of an arrangement of tracks in an information storage region and tracks in a test writing region on the magnetic disk;

FIG. 10 is an exemplary enlarged diagram of the arrangement of the tracks in the information storage region and the tracks in the test writing region on the magnetic disk;

FIG. 11 is an exemplary graph of a position difference between the recording dots and the test writing dots in the circumferential direction illustrated in FIG. 10;

FIG. 12 is an exemplary diagram of a relationship between a clock generated by a clock generating module in an HDD and patterns and bits on a magnetic disk according to a second embodiment of the invention; and

FIG. 13 is an exemplary diagram of a relationship between a clock generated by a clock generating module of an HDD and patterns and bits on a magnetic disk according to a third embodiment of the invention.

### DETAILED DESCRIPTION

Various embodiments according to the invention will be described hereinafter with reference to the accompanying drawings. In general, according to one embodiment of the invention, an information storage medium comprises a plurality of sectors arranged in a circumferential direction of a disk-shaped substrate, each sector having a servo pattern that is formed on the substrate and in which information indicating a position in a radial direction of the substrate is magnetically recorded, and a plurality of recording dots that is arranged with a predetermined pitch in the circumferential direction of the substrate and in which information is to be magnetically recorded. The servo pattern has a magnetic pattern arranged in the circumferential direction with a pitch having a predetermined integral ratio to the pitch of the recording dots. A recording dot arranged nearest to the servo pattern among the recording dots comprised in each sector is arranged at a position having a constant phase relationship to the pitch of the servo pattern of the sector comprising the recording dots in any of the sectors.

According to another embodiment of the invention, an information storage apparatus comprises an information storage medium, and a recording module configured to record information in the information storage medium while relatively moving along a circumference of the information storage medium. The information storage medium comprises a plurality of sectors arranged in a circumferential direction of a disk-shaped substrate, each sector having a servo pattern that is formed on the substrate and in which information indicating a position in a radial direction of the substrate is magnetically recorded, and having a plurality of recording dots that is arranged with a predetermined pitch in the circumferential direction of the substrate and in which information is to be magnetically recorded. The servo pattern has a magnetic pattern that is arranged in the circumferential direction with a pitch having a predetermined integral ratio to the pitch of the recording dots. A recording dot arranged nearest to the servo pattern among the recording dots comprised in each sector is arranged at a position having a constant phase relationship to the pitch of the servo pattern of the sector comprising the recording dots in any of the sectors.

According to still another embodiment of the invention, an information storage medium comprises a plurality of sectors arranged in a circumferential direction of a disk-shaped substrate, each sector having a servo pattern that is formed on the substrate and in which information indicating a position in a radial direction of the substrate is magnetically recorded, and having a plurality of recording dots that is arranged with a predetermined pitch in the circumferential direction of the substrate and in which information is to be magnetically recorded, and a plurality of test writing sectors each having the servo pattern and a plurality of test writing dots arranged in a circumference shape with a test writing pitch different from the pitch of the recording dots along an arrangement of the recording dots. The pitch of the recording dots is 1/N (N is a natural number) of a length in the circumferential direction of a region in which the recording dots are arranged in the sectors. The pitch of the test writing dots is 1/(N±K) (K is a natural number) of a length in the circumferential direction of a region in which the test writing dots are arranged in the test writing sectors.

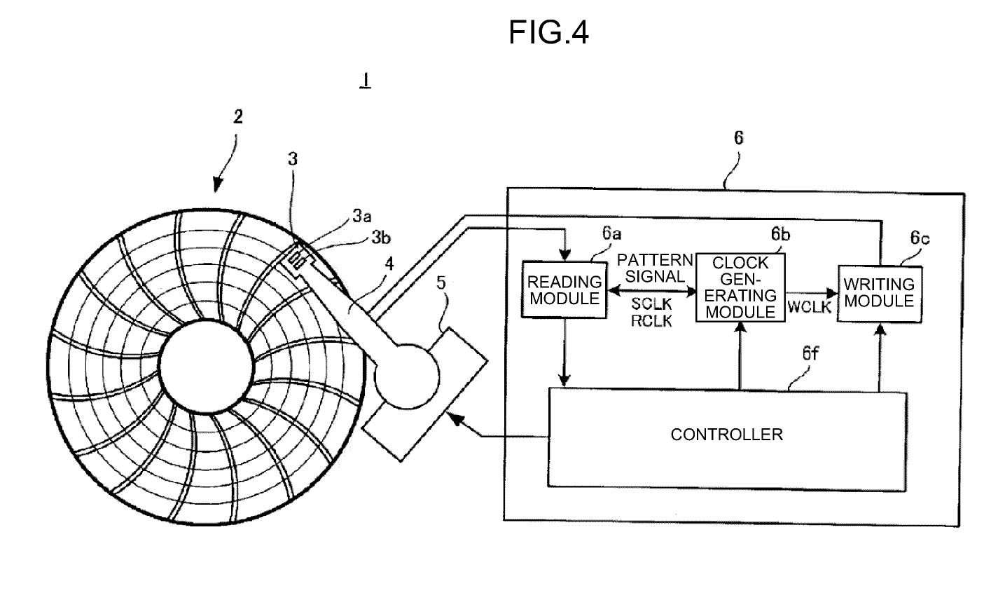

FIG. 4 is an exemplary diagram of a hard disk drive (HDD) that is a specific first embodiment of the information storage apparatus.

A hard disk drive (HDD) 1 has a magnetic disk 2, a magnetic head 3, a moving arm 4, an arm driving module 5, and a control circuit 6. The magnetic head 3 reads and writes information from and to the magnetic disk 2. The arm 4 moves the magnetic head 3 in the radial direction of the magnetic disk. The arm driving module 5 rotationally drives the arm 4. The control circuit 6 controls each module in the HDD 1 as well as receiving and transmitting signals from and to the magnetic head 3.

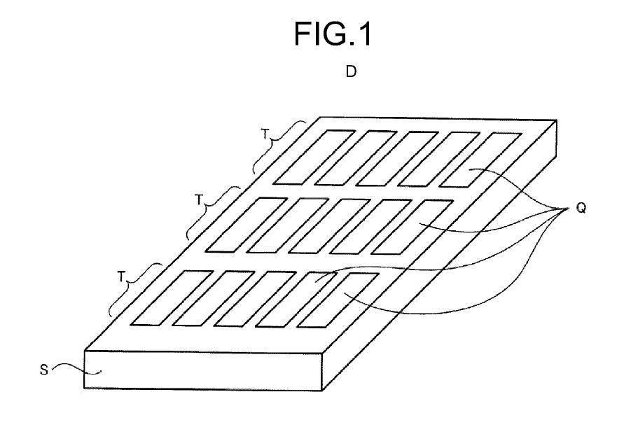

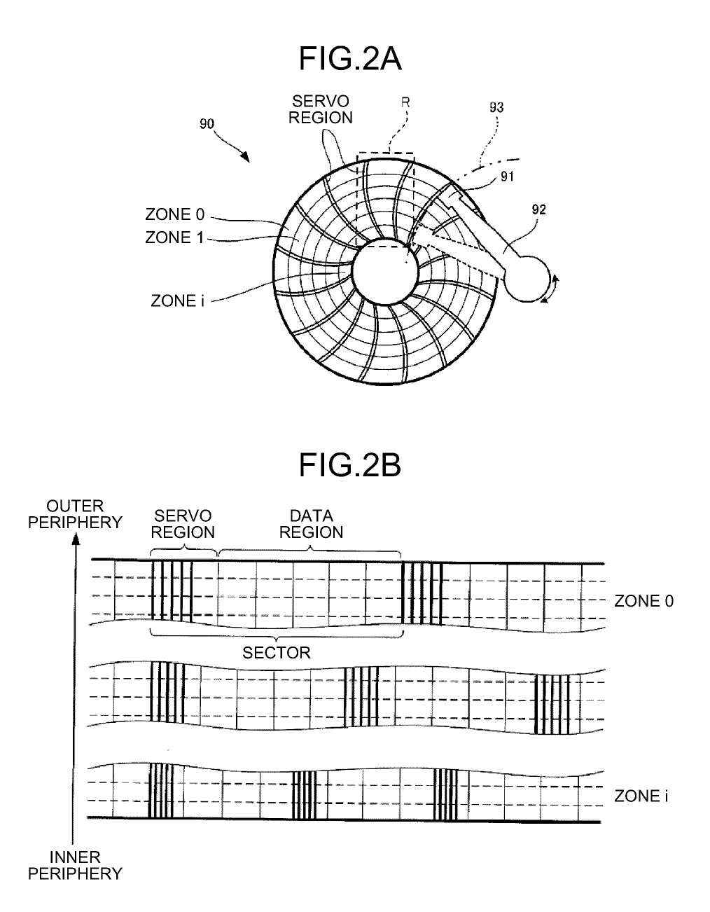

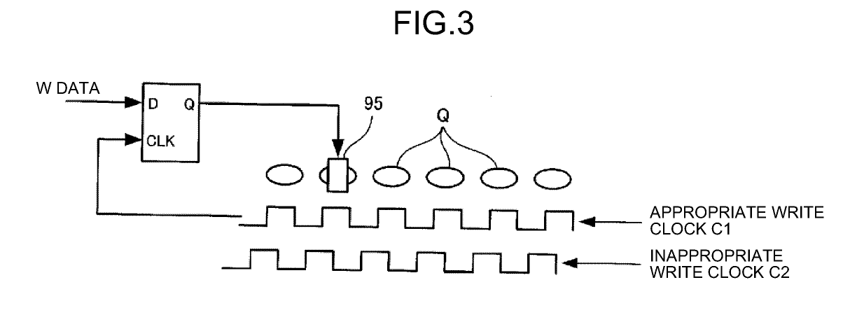

The magnetic disk 2 is a magnetic disk of the patterned media system. The magnetic disk 2 has a basic structure that comprises a disk-shaped substrate S and a plurality of recording dots Q arranged on the substrate S, and this structure is the same as the structure explained with reference to FIG. 1. The magnetic disk 2 is one example of the information storage medium mentioned above.

The magnetic head 3 has a read head 3a and a write head 3b that are provided with a distance therebetween. The write head 3b is one example of the recording module mentioned above.

The control circuit 6 comprises a reading module 6a, a writing module 6c, a clock generating module 6b, and a controller 6f. The reading module 6a receives a signal output from the read head 3a. The writing module 6c supplies a signal of information to be recorded to the write head 3b. The clock generating module 6b supplies a servo clock SCLK and a read clock RCLK to the reading module 6a and supplies a write clock WCLK to the writing module 6c. The controller 6f controls the entire control circuit 6 as well as driving the arm driving module 5 to move the magnetic head 3. The reading module 6a supplies a signal that is read from a servo preamble when the read head 3a passes a servo pattern to the clock generating module 6b. The clock generating module 6b generates the servo clock SCLK based on the signal of the servo preamble supplied from the reading module 6a. The clock generating module 6b also generates the read clock RCLK having a predetermined integral ratio with respect to the signal of the servo preamble. In addition, the clock generating module 6b generates the write clock WCLK that has the same integral ratio as that of the read clock RCLK with respect to the signal of the servo preamble and a constant phase shift with respect to the read clock RCLK. The phase shift between the read clock and the write clock is set by the controller 6f. The controller 6f detects the position of the magnetic head 3 based on the servo information that is read from the servo pattern according to the servo clock SCLK and transmitted via the reading module 6a. The controller 6f drives the arm driving module 5 to move the magnetic head 3 to a desired position.

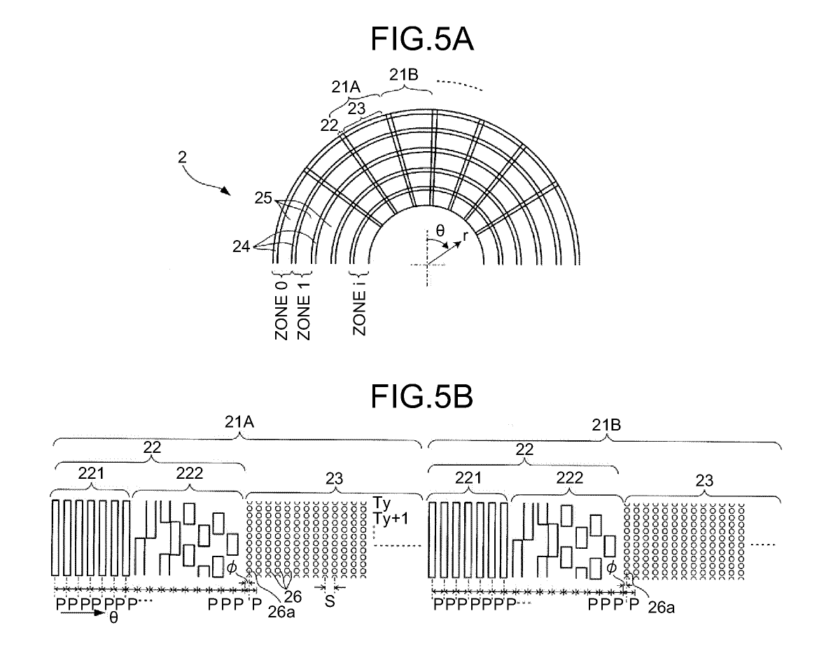

FIGS. 5A and 5B are exemplary detailed diagrams of the magnetic disk illustrated in FIG. 4.

A half part of the magnetic disk 2 is illustrated in FIG. 5A, and a plurality of tracks T (T_{y}, T_{y+1}, . . . ) is linearly expanded and illustrated in FIG. 5B.

On the magnetic disk 2, the tracks T (T_{y}, T_{y+1}, . . . ) are formed with the columns of the recording dots arranged on the circumference of the circle. Each track is divided by a servo pattern 22. In the tracks, one sector 21 is formed with a region from a servo region to just front of the next servo region. In other words, for each track on the magnetic disk 2, a plurality of sectors 21 (21A, 21B, . . . ) is arranged in the circumferential direction of the magnetic disk 2, and each sector 21 has one servo pattern 22 and one recording dot region 23.

The regions on the magnetic disk 2 are divided into a plurality of zones from zone 0 to zone i in the radial direction. Each zone has a test writing region 24 and an information storage region 25 that divide each zone in the radial direction. The tracks belonging to any of the test writing region 24 and the information storage region 25 have the sectors 21. The arrangement of the recording dots in the test writing region 24 is different from the arrangement of the recording dots in the information storage region 25. The arrangement in the test writing region 24 will be explained later, and the arrangement in the information storage region 25 will now be explained. FIG. 5B illustrates the tracks for two sectors 21A and 21B in the information storage region 25.

Each sector 21 has the servo pattern 22 and the recording dot region 23 in which recording dots 26 are arranged. In the recording dots 26, information is to be recorded. Information indicating a position in the radial direction of the magnetic disk 2 is magnetically recorded in the servo pattern 22. The servo pattern 22 has a position information pattern 222 and servo preambles 221 serving as a reference of the timing of reading the position information pattern 222. A track number and a sector number for identifying a position on the magnetic disk 2, and burst signal information for detecting a deviation from the center of the tracks are recorded in the position information pattern 222. The servo preambles 221 are arranged at the position read by the magnetic head 3 earlier than the position information pattern 222, and arranged at a constant pitch p in the circumferential direction of the magnetic disk 2. The servo preambles 221 is one example of the magnetic pattern mentioned earlier.

The recording dots 26 are arranged in a single zone at intervals conforming to a predetermined rule so as to be read by using a read clock that has the same cycle and to be written by using a write clock that has the same cycle. More particularly, the same number of the recording dots 26 are arranged in each track T (T_{y}, T_{y+1}, . . . ) in one zone. In other words, the recording dots 26 are arranged at the constant intervals with respect to a center angle θ of the magnetic disk 2, that is, at the same pitch s. For the individual tracks T (T_{y}, T_{y+1}, . . . ), the recording dots 26 are arranged at the same pitch s in the tracks T. When the magnetic disk 2 rotates in the HDD 1 and the read head 3a or the write head 3b relatively moves on the tracks T, the time period at which the read head 3a or the write head 3b passes a recording dot 26a is constant in any tracks T in one zone.

The servo preambles 221 are arranged at a pitch p having a predetermined integral ratio N:M with respect to the pitch s of the recording dots. As the integral ratio, a ratio 1:1 in which both pitches are equivalent to each other, a simple integral multiple or an integral submultiple, such as 1:2 or 2:1, or a ratio 2:3 can be employed. The values of N and M are preferably natural numbers equal to or less than 10, for example, because the values are dividing ratios of clock signals.

Among the recording dots 26, the recording dot 26a arranged nearest to the servo pattern 22 is at a position having a phase relationship φ to the pitch p of the servo preambles 221. More particularly, as illustrated in FIG. 5B, if the pitch p of the servo preambles 221 is repeatedly extended toward the recording dots 26, the recording dot 26a is arranged at the position of the phase φ in the pitch. The phase relationship φ between the recording dot 26a arranged nearest to the servo pattern 22 and the servo preambles 221 arranged at the pitch φ is constant in any of the sectors (21A, 21B, . . . ). More particularly, in any of the sectors (21A, 21B, . . . ), the recording dot 26a arranged nearest to the servo pattern 22 is arranged at a constant distance from the servo preambles 221. This positioning enables writing and reading the information to and from the recording dots 26 based on the clock timing synchronized with the servo preambles 221. Before a further explanation of this, the generation of the clock will be explained.

The clock generating module 6b illustrated in FIG. 4 generates the servo clock SCLK that determines the timing of reading the following position information pattern 222 based on the signal read by the read head 3a from the servo preambles 221. The clock generating module 6b also generates the read clock RCLK that determines the timing of reading from the recording dots 26 and the write clock WCLK by multiplying/dividing the servo clock SCLK based on the integral ratio of the pitches p and s.

The signal read by the read head 3a from the position information pattern 222 is supplied to the controller 6f via the reading module 6a. The controller 6f controls a position of the magnetic head 3 with the read signal. The signal read by the read head 3a from the recording dot 26 is also supplied to the controller 6f. The signal output from the controller 6f is supplied to the write head 3b, and the information of the signal is written to the recording dot 26 at the timing of the write clock WCLK.

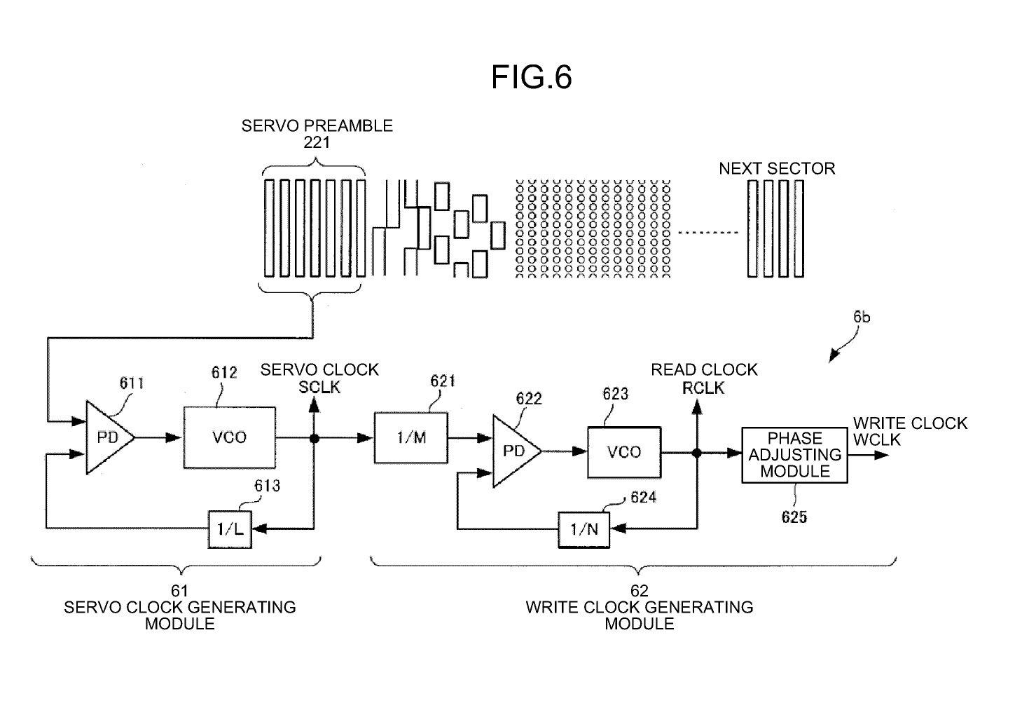

FIG. 6 is an exemplary block diagram of the internal configuration of the clock generating module illustrated in FIG. 4.

The clock generating module 6b illustrated in FIG. 6 comprises a servo clock generating module 61 and a write clock generating module 62.

The servo clock generating module 61 comprises a phase-locked loop (PLL) circuit and generates the servo clock SCLK synchronized with the signal read from the servo preambles 221. More particularly, the servo clock generating module 61 comprises a phase detector (PD) 611, a voltage controlled oscillator (VCO) 612, and a 1/L frequency divider 613. The 1/L frequency divider 613 is a circuit that divides a signal frequency by L. The value of L is 1 in the embodiment. In this case, the servo clock generating module 61 outputs the servo clock SCLK having the same frequency as the signal read from the servo preambles 221. Note that the value of L may be a natural number other than 1.

The write clock generating module 62 generates the read clock RCLK and the write clock WCLK that are synchronized with the servo clock SCLK. This means the write clock generating module 62 generates the read clock RCLK and the write clock WCLK that are synchronized with the signal read from the servo preambles 221. The write clock generating module 62 also comprises a PLL circuit, more particularly, comprises a 1/M frequency divider 621, a PD 622, a VCO 623, and a 1/N frequency divider 624. The dividing ratio M:N of the 1/M frequency divider 621 to the 1/N frequency divider 624 is set so as to be equivalent to the ratio of the pitch s of the recording dot to the pitch p of the servo preambles 221.

The write clock generating module 62 also comprises a phase adjusting module 625. The phase adjusting module 625 adjusts the phase relationship between the read clock RCLK and the write clock WCLK and is formed with, for example, a programmable delay circuit. The phase is adjusted to correct a position difference between the read head 3a and the write head 3b on the magnetic head 3 (FIG. 4). The amount of the phase is controlled by the controller 6f. While the magnetic head 3 accesses one zone, the set amount of the phase is fixed. The method of determining the set amount of the phase will be explained later.

In the clock generating module 6b, the servo clock generating module 61 and the write clock generating module 62 generate the read clock RCLK and the write clock WCLK that are synchronized with the signal read from the servo preambles 221.

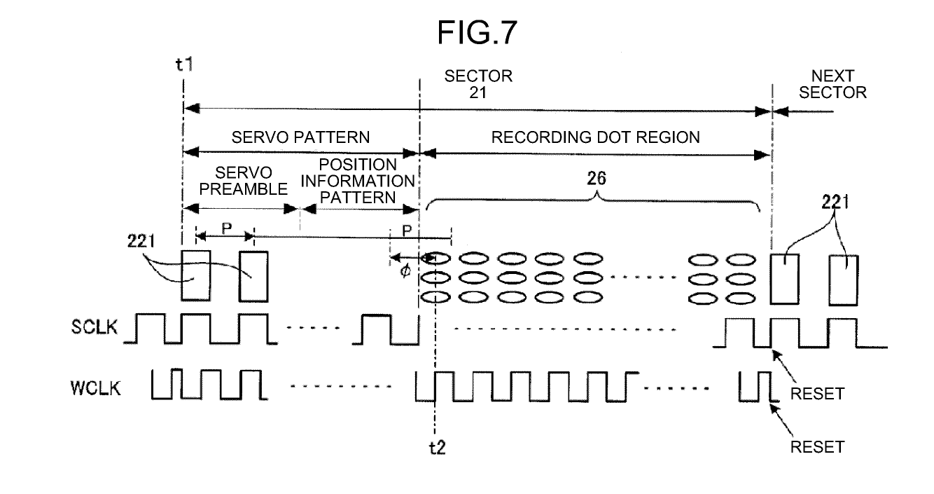

FIG. 7 is an exemplary diagram of the relationship between the clock generated by the clock generating module illustrated in FIG. 6 and the patterns and the bits on the magnetic disk. FIG. 7 illustrates the waveforms of the servo clock SCLK and the write clock WCLK that change with a lapse of time. Over the waveforms, the servo preambles 221 and the recording dots 26 of the sector 21 over which the magnetic head 3 passes with the lapse of the same time are illustrated.

When the magnetic head 3 (see FIG. 4) reaches the servo preambles 221 of the sector 21 at a timing t1 illustrated in FIG. 7, a signal is read from the servo preambles 221. As a result, the clock generating module 6b (see FIG. 4) generates the servo clock SCLK and the write clock WCLK that correspond to the read signal. The servo clock SCLK and the write clock WCLK are continuously generated until the magnetic head 3 reaches the servo preambles 221 of the next sector after passing the servo preambles 221. The dividing ratio M:N of the 1/M frequency divider 621 and the 1/N frequency divider 624 in the clock generating module 6b is set so that the write clock WCLK has a cycle corresponding to the pitch s of the recording dots 26. Consequently, the cycle of the write clock WCLK matches with the cycle in which the magnetic head 3 passes over the recording dots 26. In the embodiment, when the magnetic head 3 reaches the next servo preambles 221, the clocks SCLK and WCLK are generated based on the new servo preambles 221. Thus, these clocks SCLK and WCLK are discontinuous. The state of discontinuity is referred to as reset of a clock.

Among the recording dots 26, the recording dot 26a arranged nearest to the servo pattern 22 is at a position having the constant phase relationship φ to the pitch p of the servo preambles 221. The phase relationship φ to the pitch p of the servo preambles 221 is constant in any sector. Consequently, the phase of the write clock WCLK at a timing t2 at which the recording dot 26a passes over the magnetic head 3 is constant in all the sectors in the track. Accordingly, the phase of the write clock WCLK is shifted and adjusted for a certain amount. Therefore, the timing of writing information to the recording dots 26 with the write clock WCLK is matched with the passage timing of the recording dots 26 in any sectors.

With the magnetic disk 2 of the embodiment, information can be written to the recording dots 26 without using dedicated patterns for write clock generation, such as the write preamble. Consequently, it is possible to increase the recording capacity by removing the write preamble in the arrangement of the recording dots.

Next, the phase adjustment of the write clock WCLK will be explained.

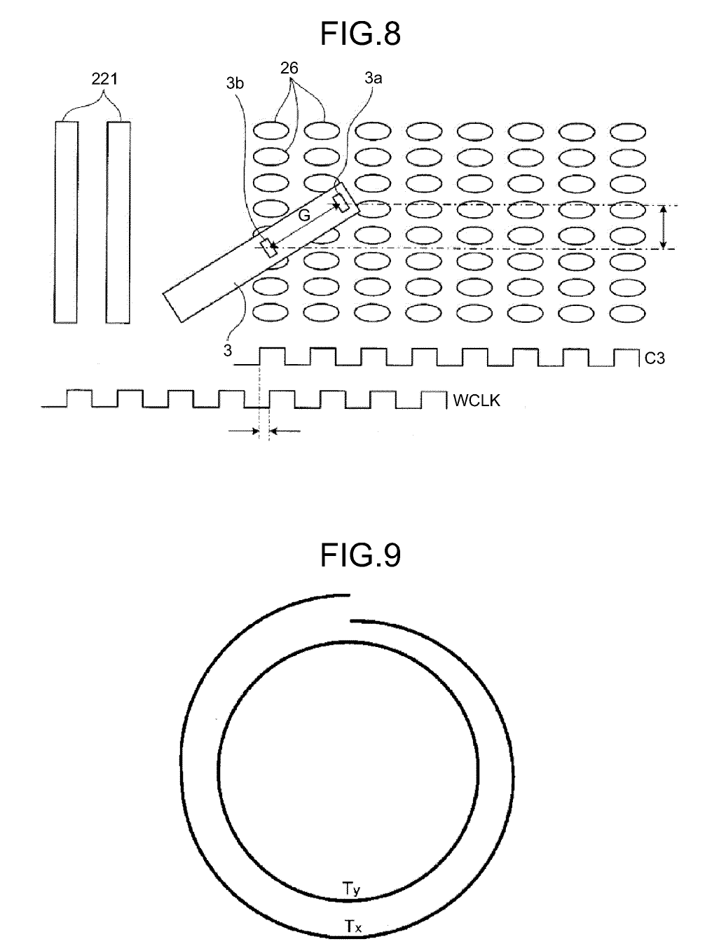

FIG. 8 is an exemplary diagram of the phase relationship between the recording dots and the write clock WCLK. FIG. 8 schematically illustrates the servo preambles 221 and the recording dots 26 on the magnetic disk 2 and the magnetic head 3.

The magnetic head 3 comprises the read head 3a and the write head 3b with a distance G therebetween. Accordingly, the optimal timing of reading information from the recording dots 26 by the read head 3a and the optimal timing of writing information by the write head 3b are different. The distance G has a deviation for each product. In addition, the read head 3a and the write head 3b have a distance in the radial direction of the magnetic disk 2 because the read head 3a and the write head 3b are obliquely arranged with respect to the tracks.

The adjustment of the phase relationship in the phase adjusting module 625 illustrated in FIG. 6 is to correct the position difference between the read head 3a and the write head 3b of the magnetic head 3.

The amount of the phase to be adjusted may be determined by repeating writing and reading to and from the recording dots 26 while slightly changing the phase condition of the write clock to find an optimal phase. The method, however, requires a large number of trials to find the optimal phase. In the embodiment, the test writing region 24 (FIG. 5A) different from the information storage region 25 described above is provided on the magnetic disk 2, thereby reducing the trial times.

In the sectors of the test writing region 24 on the magnetic disk 2, servo patterns and recording dots are provided similarly to the information storage region 25. However, the pitch of the recording dots in the test writing region 24 is different from that in the information storage region 25. The recording dots in the test writing region 24 (hereinafter, referred to as test writing dots) are arranged in a spiral shape that continuously changes in the radial direction as advancing in the circumferential direction.

FIG. 9 is an exemplary schematic of the arrangement of the tracks of the recording dots in the information storage region and the tracks of the recording dots in the test writing region on the magnetic disk.

As explained with reference to FIG. 5A, the track T_{y} in the information storage region 25 is a circle, and the track Tₓ in the test writing region 24 has a spiral shape. Specifically, the test writing dots in the test writing region 24 are arranged in a spiral shape that continuously changes in the radial direction as advancing in the circumferential direction. In FIG. 5B, the spiral shape is extremely expanded and illustrated so as to be easily viewed, but the actual radius of the track Tₓ in the test writing region 24 is changed within the range of one track width.

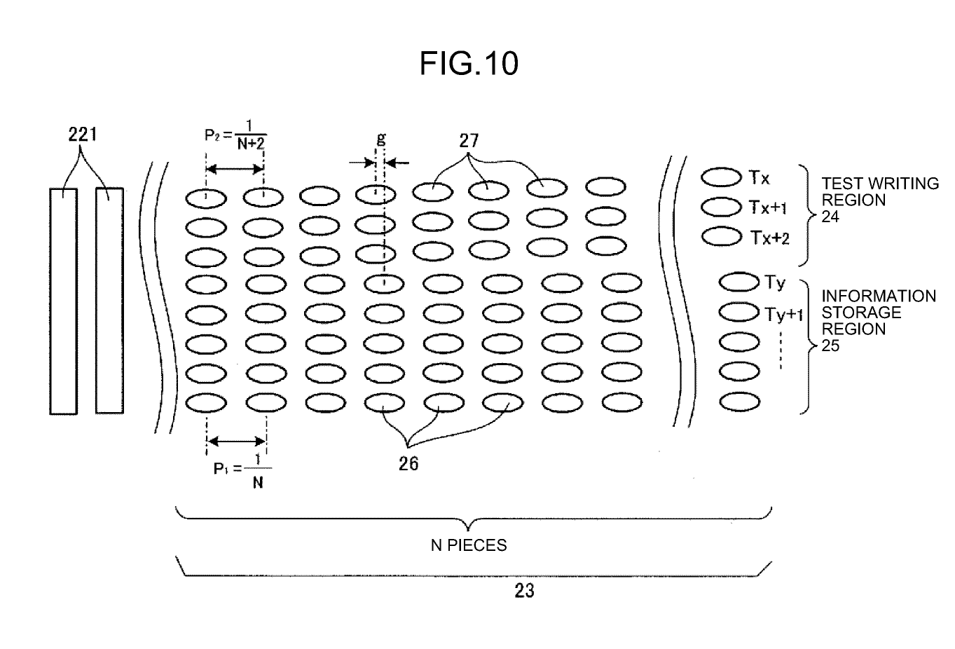

FIG. 10 is an exemplary enlarged diagram of the arrangement of the tracks in the information storage region and the tracks in the test writing region on the magnetic disk. FIG. 10 illustrates the tracks T_{y}, T_{y+1} . . . in the information storage region 25 and the tracks Tₓ, Tₓ₊₁, Tₓ₊₂ in the test writing region 24 for one sector.

The test writing dots 27 are arranged while continuously changing in the radial direction as advancing in the circumferential direction of the magnetic disk. In the tracks T_{y}, T_{y+1} . . . of the information storage region 25, N pieces of the recording dots 26 per sector are arranged. Accordingly, the arrangement cycle of the recording dots 26, that is, the pitch p1 is 1/N (N is a natural number) of the length in the circumferential direction of the recording dot region 23 in which the recording dots are arranged. On the other hand, in the tracks Tₓ, Tₓ₊₁, Tₓ₊₂ of the test writing region 24, N±K pieces of the test writing dots 27 per sector are arranged. Accordingly, the arrangement cycle of the test writing dots 27, that is, the pitch p2 is 1/(N±K) (K is a natural number) of the length in the circumferential direction of the recording dot region 23. FIG. 10 illustrates an example where the value of K is 2 and the sign is +.

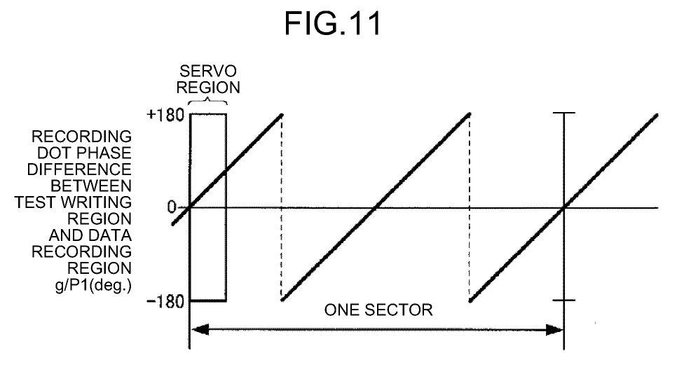

FIG. 11 is an exemplary graph of a ratio of the position difference g in the circumferential direction of the recording dots and the test writing dots illustrated in FIG. 10 to the pitch p1, that is, the phase difference g/p1. The graph of the phase difference has a waveform repeating for the value of K per sector. FIG. 11 illustrates an example where the value of K is 2. If K is 2, the graph of the phase difference has a waveform repeating twice in one sector. In this case, test writing can be performed with a phase difference from −180° to +180° near the center of sectors except for those in the region of the servo pattern 22.

To perform the test writing to the magnetic disk 2, the write clock WCLK whose cycle is synchronized with the signal read from the servo preambles 221 is generated by the clock generating module 6b (see FIG. 4) similarly to the recording to the recording dots 26 of the information storage region 25. The cycle of the write clock WCLK corresponds to the pitch p1 of the recording dots 26, that is, 1/N of the length in the circumferential direction of the recording dot region 23. In addition, the cycle of the write clock WCLK is shifted from the pitch p2 of the test writing dots 27, that is, 1/(N+2) of the length in the circumferential direction of the recording dot region 23. The same information is written in all the test writing dots 27 of all the sectors on the track Tₓ with this cycle. After that, the information is read from the test writing dots 27 as well as the amplitude of the read signal is measured to specify the test writing dot 27 whose amplitude is the maximum. This means the information is written to the specified test writing dot 27 with the maximum efficiency. The phase shift from the recording dot 26 in the specified test writing dot 27 is apparent in advance as illustrated in FIG. 11, and the phase shift is the amount of the phase to be set in the phase adjusting module 625 illustrated in FIG. 6. Furthermore, a shift correction amount in the radial direction can be obtained from the position in the radial direction illustrated in FIG. 9 by the position of the test writing dot 27 whose amplitude is the maximum on the circumference of the magnetic disk 2.

With the magnetic disk 2 of the embodiment, as compared with the method that writes information to the recording dots of the information storage region 25 and confirms the result while slightly changing the shift condition of the phase and the radial direction, the required time for acquiring the correction amount can be shortened.

In the explained first embodiment, as explained with reference to FIG. 7, the generated clocks SCLK and WCLK are reset every time the magnetic head 3 reaches the servo preambles 221 when the clock generating module 6b generates the clocks SCLK and WCLK. This means the clocks are discontinuous. Next, an HDD of a second embodiment of the invention avoiding the reset of the servo clock SCLK will be explained. Unlike the HDD 1 of the first embodiment, in the HDD of the second embodiment, the length in the circumferential direction of each sector 21 in the magnetic disk 2 is an integral multiple of the pitch p of the servo pattern 22. Other points are the same as the first embodiment, whereby elements are explained with the same numerals and letters as those of the first embodiment.

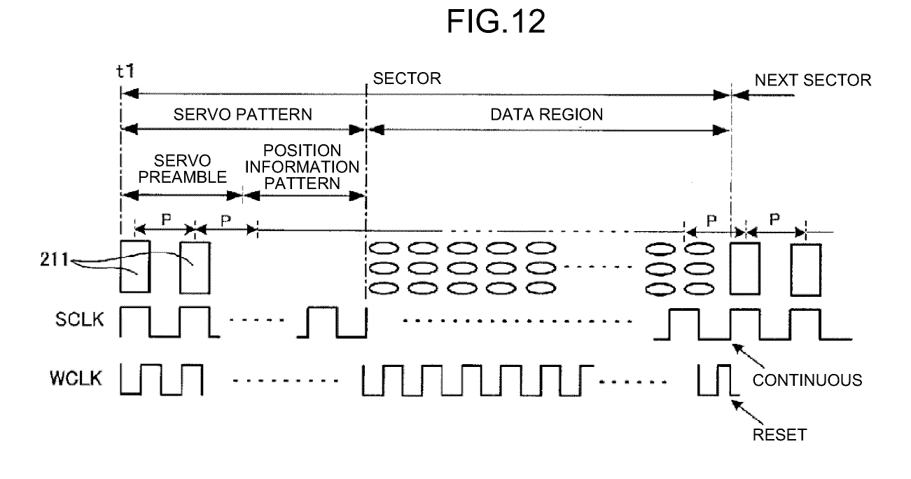

FIG. 12 is an exemplary diagram of a relationship between a clock generated by a clock generating module in the HDD and patterns and bits on the magnetic disk according to the second embodiment.

When the magnetic head 3 (see FIG. 4) reaches the servo preambles 221 of the sector 21 at time t1 illustrated in FIG. 12, the signal is read from the servo preambles 221. The clock generating module 6b (see FIG. 4) generates the servo clock SCLK and the write clock WCLK that are synchronized with the read signal. The servo clock SCLK and the write clock WCLK are continuously generated until the magnetic head 3 reaches the servo preambles 221 of the next sector after the magnetic head 3 passes over the servo preambles 221. When the magnetic head 3 reaches the next servo preambles 221, synchronization with the new servo preambles 221 is achieved. In the HDD of the second embodiment, the length in the circumferential direction of each sector 21 is an integral multiple of the pitch p of the servo pattern 22. Consequently, the servo clock SCLK is not reset thereby being continuous.

According to the second embodiment, the time for maintaining the synchronization can be shortened because the servo clock SCLK is not reset for each sector. Consequently, the arrangement region of the servo preamble can be downsized. This means that it is preferable that the length in the circumferential direction of the sectors be an integral multiple of the pitch of the servo pattern.

Next, a third embodiment of the invention in which the reset of the write clock WCLK is avoided will be explained. In an HDD of the third embodiment, the length in the circumferential direction of each sector 21 in the magnetic disk 2 is an integral multiple of the pitch p of the servo pattern 22, and is an integral multiple of the pitch s of the recording dots 26, unlike the HDD 1 of the first embodiment. Other points are the same as the first embodiment, therefore each elements will be explained with the same numerals and letters as the first embodiment.

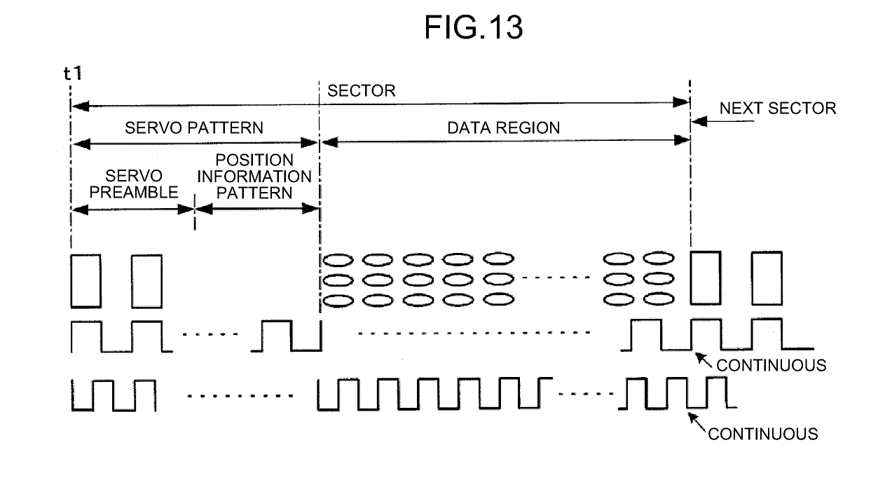

FIG. 13 is an exemplary diagram of a relationship between a clock generated by a clock generating module in the HDD and patterns and bits on the magnetic disk according to the third embodiment.

When the magnetic head 3 (see FIG. 4) reaches the servo preambles 221 of the sector 21 at time t1 illustrated in FIG. 13, the signal is read from the servo preambles 221. The clock generating module 6b (see FIG. 4) generates the servo clock SCLK and the write clock WCLK that are synchronized with the read signal. When the magnetic head 3 reaches the next servo preambles 221, synchronization with the new servo preambles 221 is achieved. In the HDD of the third embodiment, the length in the circumferential direction of each sector 21 is an integral multiple of the pitch p of the servo pattern 22. In the HDD of the third embodiment, in addition, because the length in the circumferential direction of each sector 21 is an integral multiple of the pitch s of the recording dots 26, neither the servo clock SCLK nor the write clock WCLK is reset, thereby being continuous.

According to the third embodiment, because the write clock WCLK is not reset for each sector, the stability of the write timing with the write clock WCLK can be improved. This means that it is preferable that the length in the circumferential direction of each sector be an integral multiple of the pitch of the recording dots.

According to an embodiment of the information storage medium and the information storage apparatus of the invention, the recording capacity of the information storage medium can be increased.

According to an embodiment, in the servo pattern, information indicating a position in the radial direction for positioning the magnetic head is recorded, and the magnetic pattern for generating a timing of reading the information is comprised. With the basic forms of the information storage medium and the information storage apparatus, the write clock is generated by multiplying and dividing a signal read from the magnetic pattern of the servo pattern. As a result, it is possible to accurately write the information in the recording dots based on the generated write clock. Accordingly, the preamble for generating the write clock can be removed from the sectors and the recording dots can be arranged instead, whereby the recording capacity is increased.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information storage medium comprising:
a plurality of sectors arranged in a circumferential direction of a disk-shaped substrate, each sector having a servo pattern that is formed on the substrate and in which information indicating a position in a radial direction of the substrate is magnetically recorded, and
a plurality of recording dots that is arranged with a predetermined pitch in the circumferential direction of the substrate and in which information is to be magnetically recorded, and wherein
the servo pattern has a magnetic pattern arranged in the circumferential direction with a pitch having a predetermined integral ratio to the pitch of the recording dots, and
a recording dot arranged nearest to the servo pattern among the recording dots comprised in each sector is arranged at a position having a constant phase relationship to the pitch of the servo pattern of the sector comprising the recording dots in any of the sectors.

2. The information storage medium according to claim 1, wherein each sector has a length in the circumferential direction of an integral multiple of the pitch of the servo pattern.

3. The information storage medium according to claim 2, wherein each sector has a length in the circumferential direction of an integral multiple of the pitch of the recording dot.

4. An information storage apparatus comprising:
an information storage medium; and
a recording module configured to record information in the information storage medium while relatively moving along a circumference of the information storage medium, and wherein
the information storage medium comprises a plurality of sectors arranged in a circumferential direction of a disk-shaped substrate, each sector having a servo pattern that is formed on the substrate and in which information indicating a position in a radial direction of the substrate is magnetically recorded, and having a plurality of recording dots that is arranged with a predetermined pitch in the circumferential direction of the substrate and in which information is to be magnetically recorded,
the servo pattern has a magnetic pattern that is arranged in the circumferential direction with a pitch having a predetermined integral ratio to the pitch of the recording dots, and
a recording dot arranged nearest to the servo pattern among the recording dots comprised in each sector is arranged at a position having a constant phase relationship to the pitch of the servo pattern of the sector comprising the recording dots in any of the sectors.

5. An information storage medium comprising:
a plurality of sectors arranged in a circumferential direction of a disk-shaped substrate, each sector having a servo pattern that is formed on the substrate and in which information indicating a position in a radial direction of the substrate is magnetically recorded, and having a plurality of recording dots that is arranged with a predetermined pitch in the circumferential direction of the substrate and in which information is to be magnetically recorded; and
a plurality of test writing sectors each having the servo pattern and a plurality of test writing dots arranged in a circumference shape with a test writing pitch different from the pitch of the recording dots along an arrangement of the recording dots, and wherein
the pitch of the recording dots is 1/N (N is a natural number) of a length in the circumferential direction of a region in which the recording dots are arranged in the sectors, and
the pitch of the test writing dots is 1/(N±K) (K is a natural number) of a length in the circumferential direction of a region in which the test writing dots are arranged in the test writing sectors.

6. The information storage medium according to claim 5, wherein the N is 2.

7. The information storage medium according to claim 5, wherein the test writing dots are arranged on the substrate in a spiral shape that continuously changes in the radial direction as advancing in the circumferential direction.
